(19) United States
(12) Patent Application Publication
(10) Pub. No.: US 2018/0234506 A1
(43) Pub. Date: Aug. 16, 2018

(54) SYSTEM AND METHODS FOR ESTABLISHING VIRTUAL CONNECTIONS BETWEEN APPLICATIONS IN DIFFERENT IP NETWORKS

(71) Applicant: Gu Zhang, Shanghai (CN)

(72) Inventor: Gu Zhang, Shanghai (CN)

(21) Appl. No.: 15/893,618

(22) Filed: Feb. 10, 2018

Related U.S. Application Data
(60) Provisional application No. 62/458,609, filed on Feb. 14, 2017.

(51) Int. Cl. H04L 29/08

(52) U.S. Cl. CPC H04L 67/141; H04L 69/16; H04L 67/02

(57) ABSTRACT

System and methods disclosed are for establishing and maintaining virtual IP connections between network applications in isolated IP networks. The system comprises a relay server subsystem comprising one or more relay servers comprising one or more public addressable control servers and one or more public addressable forwarding servers; and a relay agent subsystem comprising one or more relay agents comprising one or more origination agents and one or more termination agents residing in different networks, serving the client applications in the origination networks and the server applications in the destination networks respectively, to build the virtual TCP connections between the client applications and the server applications. The relay server subsystem further comprises a data store for storing user information and relay agent information. WebSocket protocol is used to create full-duplex TCP connections between relay agents and the relay servers. Transport Layer Security (TLS) technology may be utilized to secure those connections.

### REFERENCE TO RELATED APPLICATIONS

This application claims the priority and incorporates by reference of U.S. Provisional Patent Applications 62/458,609, filed on Feb. 14, 2017.

### BACKGROUND OF THE INVENTION

### Field of the Invention

The present invention relates to the field of computer network communications. Particularly, the present invention relates to connections between applications in different networks.

### Motivation and Description of Related Art

On-demand connections between two network applications in different IP networks isolated to each other are very useful for scenarios such as remote support from the supplier to solve a problem on sold application systems running on a client network, or integration between applications in different organizations for joint-development. These scenarios are common in modern network-based industries such as Information Technology industry and Telecom industry. Since networks belong to different organizations and do not trust each other, creating permanent connections are either too expensive, time-consuming or not allowed due to the information security concerns.

A commonly used solution to create such temporary communications is to remotely control an agent device (a personal computer, for example) in the destination network via remote desktop technology (such as team viewer, Chrome remote desktop, etc.), and then remotely run the client application on the relay agent device to communicate with the destination server application.

There are many problems with this solution. A remote desktop normally exclusively controls the remote device, so it is hard to allow multi-user controls. Transmitting Graphic User Interface (GUI) data is a significant extra workload to the network, especially when the bandwidth is low or the network is not stable. It is a huge security risk to the destination network since a remote user can control a desktop device inside the network. It is also a huge security risk to the origination network since the client application has to be put on the destination network.

Using intermediate entities to relay data between two network entities is a common networking model, and people are trying to find methods to solve the above problem in different ways under the relay model. For example, U.S. Pat. No. 9,002,980 B2 04 by Felix Shedrinsky described a method of transferring data between two applications in different IP networks by utilizing HTTP protocol. The problem is HTTP connections are not persistent, so it is complex and inefficient to be used for session-based communications. Meanwhile, issues such as application session setup and termination, necessary application data manipulation, multi-application, multi-connection management or information security which has to be addressed in a real system are not described.

Therefore, it is highly necessary to create a realistic solution for secure, stable and multi-connection/multi-user enabled on-demand communications between specific applications in different IP networks.

### SUMMARY OF THE INVENTION

The objective of the present invention is to create a reliable solution for secure, stable and multi-channel/multi-user enabled on-demand communications between specific applications in different IP networks.

In one aspect of the present invention, a computer network protocol named WebSocket, that provides full-duplex communication over a single TCP connection is developed. By using the WebSocket protocol, the disclosure presents a data relay system that allows creating virtual full-duplex TCP connections between a specific origination client application and a specific destination server application in separate networks, which are referred to and managed as channels hereafter. In a preferred embodiment, the communications are on-demand and multichannel enabled; the network operations are properly authenticated and authorized; the contents are encrypted, monitored and recorded; and the topology of an involved network is hidden from outside of the network.

In another aspect of the present invention, a user registers an account before using the relay system. The user then can control an agent application to use the WebSocket technology to initiate a full-duplex TCP connection between the relay agent and a control server and then log in to the control server. During the login process, the control server may allocate a set of forwarding servers. The forwarding server forwards application data packets between the origination agent and the termination agent for different application sessions which each is managed as a separate channel. The packets then are forwarded between the client application and server application with the relay of the two agents and the forwarding server.

In another aspect of the present invention, in a preferred embodiment, Transport Layer Security (TLS) protocol is used to secure the communications between the relay agents and the servers.

In another aspect of the present invention, an origination client has no knowledge of the actual destination network. It regards its origination agent as the destination server in its local network and sends connection requests and user data to the origination agent. A destination server has no knowledge of the actual origination network. It regards its termination agent as the origination client in its local network and accepts connection requests and user data from the termination agent.

In another aspect of the present invention, for some application protocol, since the topology of an involved network is hidden from other networks, manipulations on user data are necessary. For example, to allow an FTP client to communicate with an FTP server through the relay system, FTP proxy function in both relay agents are needed to parse and manipulate the FTP control commands, and explicitly create or destroy the corresponding data connections between an FTP client application and the client application, and between the termination agent and an FTP server application by interpreting the commands properly.

In another aspect of the present invention, an index-addressing technology is developed to address a resource among a finite set of resources by referencing them with an index, and storing/fetching its memory entrance at/from the cell of a pre-allocated array with the cell index equals to the reference index, instead of searching among the set.

The above invention aspects will be clearly stated in the drawings and detailed description of the invention.

### BRIEF DESCRIPTION OF THE DRAWINGS

FIG. 1 is a block diagram illustrating the overview of an embodiment of the disclosed relay system.

FIG. 2 is a block diagram illustrating a preferred embodiment of the multi-channel mechanism by an example.

FIG. 3 is a block diagram illustrating the critical data structures used by a relay agent embodiment.

FIG. 4 is a block diagram illustrating the data flows in a relay agent embodiment.

FIG. 5 is a block diagram illustrating the critical objects used by a relay server embodiment.

FIG. 6 is a table of sample management operations the relay system supports.

FIG. 7 is a flowchart illustrating the general control flow of a control server embodiment.

FIG. 8 is a flowchart illustrating the control flow for the login operation in a control server embodiment.

FIG. 9A is a flowchart illustrating the control flow for the creating channel operation in a control server embodiment.

FIG. 9B is a flowchart illustrating the control flow for the creating channel response handling in a control server embodiment.

FIG. 10 is a flowchart illustrating the switch-and-forward process in a forwarding server embodiment.

### REFERENCE NUMERALS IN THE DRAWINGS

Reference is now made to the following components of embodiments of the present invention:
101a private IP network instance
101b private IP network instance
101c private IP network instance
101d private IP network instance
101e private IP network instance
102a client application instance
102b client application instance
102c client application instance
103a origination agent instance
103b origination agent instance
104a edge router instance
104b edge router instance
104c edge router instance
104d edge router instance
104e edge router instance
105 public IP network
106 relay server subsystem
107 control server instances
108 forwarding server instances
109 data store instance
110b termination agent instance
110c termination agent instance
111a server application instance
111b server application instance
111c server application instance
111d server application instance
111e server application instance
201a channel instance
201b channel instance
201c channel instance
201d channel instance
201e channel instance
201f channel instance
301 interface manager definition
302 agent manager definition
302a agent manager instance
303 inbound control packet queue definition
303a inbound packet queue instance
304 relay agent definition
304a relay agent instance
305 instance id field for relay agent definition
306 peer agent adapter list definition
307 inbound control packet queue definition
307a inbound packet queue definition
308 peer agent adapter definition
309 instance id field
310 agent name field
312 service reference list definition
313 service definition
314 instance id field for service definition
315 IP address field of service definition
316 serving port field of service definition
317 protocol ID field of service definition
318 channel reference list definition
319 server socket reference
320 channel definition
321 instance id field for channel definition
322 server adapter definition
322a server adapter definition
323 telnet adapter definition
323a protocol adapter definition
324 SSH adapter definition
324a SSH adapter instance
325 TLS adapter definition
325a TLS adapter instance
326 FTP adapter definition
326a FTP adapter instance
327 HTTP adapter definition
327a HTTP adapter instance
328 WebSocket client instance reference
329 inbound data packet queue definition
329a inbound packet queue instance
330 forwarding server reference list definition
331 channel reference array definition
332 WAN manager definition
333 WebSocket client list definition
333 WebSocket client instance reference list definition
334 WebSocket client definition
334a WebSocket client instance
335 outbound WebSocket message queue definition
335a outbound WebSocket message queue instance
336 inbound WebSocket message queue definition
336a inbound WebSocket message queue instance
337 control packet definition
337a control packet instance
337b control packet instance
337c control packet instance
337d control packet instance
337e control packet instance
337f control packet instance
337g control packet instance
337i control packet instance
338 header part definition of control packet
339 instance_ID header field
339a instance_ID header field
339b instance_ID header field
339d instance_ID header field
339e instance_ID header field
339g instance_ID header field
339i instance_ID header field
339j instance_ID header field
340 operation_type field definition
340a operation_type instance
340b operation_type instance
340d operation_type instance
340e operation_type instance
340g operation_type instance
340i operation_type instance
341 message_type field definition
341b message_type instance
341d message_type instance
341e message_type instance
341g message_type instance
341i message_type instance
342 payload part of control packet definition
343 data packet definition
343a data packet instance
344 channel_ID field definition
344a channel_ID instance
344b channel_ID instance
345 payload part definition
346 encode procedure definition
346a encode procedure instance
347 decode procedure definition
347a decode procedure instance
348 dispatch procedure definition
348a dispatch procedure instance
349 account_info definition
501 target application instance
601 WebSocket server definition
602 inbound message queue definition
603 outbound message queue definition
604 session reference list definition
605 session_info array definition
606 session_info definition
606a session_info instance
606b session_info instance
606c session_info instance
607 session reference definition
608 instance_ID definition
608a instance_ID instance
608b instance_ID instance
609 channel_info_array definition
609a channel_info_array instance
609b channel_info_array instance
610 channel_info definition
610a channel_info instance
610b channel_info instance
610c channel_info instance
611 peer_instance_ID definition
611a peer_instance_ID instance
611b peer_instance_ID instance
611c peer_instance_ID instance
612 peer_channel_ID definition
612a peer_channel_ID instance
612b peer_channel_ID instance
612c peer_channel_ID instance
613 account records definition
614 authorization records definition
615 association relationship records definition
616 service records definition
701a binary message instance
701b binary message instance
702 receiving message event definition
703 on_message procedure definition
704 decode procedure definition
705 cases of operation_type
705a operation_type instance
706 request handling procedure definitions
706a on_login request handling procedure instance
707 instance_ID instance
708 sending procedure definition
708d sending procedure instance
708e sending procedure instance
801 username instance
802 password instance
803a operation_result instance
803b operation_result instance
803c operation_result instance
804 parameter reason_code instance
805a notification_type instance
805b notification_type instance
806a agent_name instance
806b agent_name instance
807 forwarding server list instance
808a access control token instance
808b access control token instance
809 origination agent instance
810 information list instance
811 termination agent list instance
812 forwarding server list instance
813 account information instance
901a channel_ID instance
901c channel_ID instance
902 procedure definition
903 case of message_type
904 procedure definition
905 case of operation_result
906 procedure definition
907 procedure definition
908a peer_channel_ID instance
908b peer_channel_ID instance
909a procedure definition
909b procedure definition
910a procedure definition
910b procedure definition
911 procedure definition
1101 on_forward procedure definition
1102 procedure definition
1103 procedure definition

### DETAILED DESCRIPTION OF THE INVENTION

In the detailed description, numerous specific details are set forth in order to provide a thorough understanding of the invention. However, it will be understood by those skilled in the art that these are specific embodiments and that the present invention may be practiced also in different ways that embody the characterizing features of the invention as described and claimed herein.

The notation “definition”, against the notation “instance”, is generally used herein to identify that the target entity is a logical design. In the Object-Oriented Programming paradigm, the similar concept is normally notated as template or class. However, it is not used to specify the entity in full detail for a specific implementation, but rather to show the necessary data structures and/or control flows of an embodiment for illustration purpose.

WebSocket Protocol is a TCP-based protocol enables full-duplex connections between IP network entities. WebSocket enables streams of messages on top of TCP. TCP alone deals with streams of bytes with no inherent concept of a message. The WebSocket protocol was standardized by the IETF as RFC 6455 in 2011. In the present disclosure, the WebSocket protocol is utilized to establish the full-duplex TCP connections between the relay agent subsystem and the relay server subsystem.

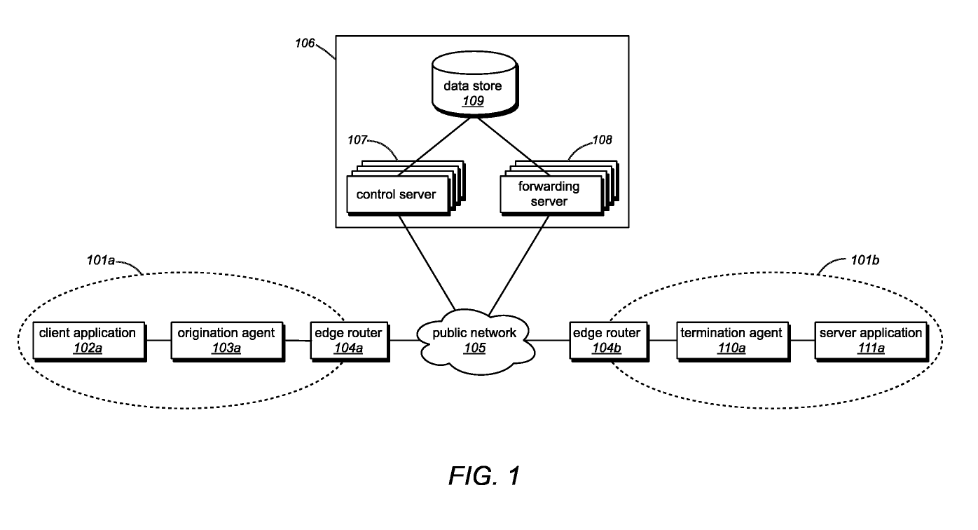

In FIG. 1, the relay server subsystem 106 comprises one or more control servers 107, a one or more forwarding servers 108 and a data store 109. A client application 102a in a private network 101a can access the public network 105, the control server 107, and the forwarding server 108 through the edge router 104a. The edge router 104a can be accessed using the Network Address Translation technology. Many edge routers also implement a firewall module for network security. Similarly, a server application 111a in another private network 101b can access the public network through the edge router 104b. However, edge routers normally do not allow an application from outside of the private network to actively access the applications inside the private network.

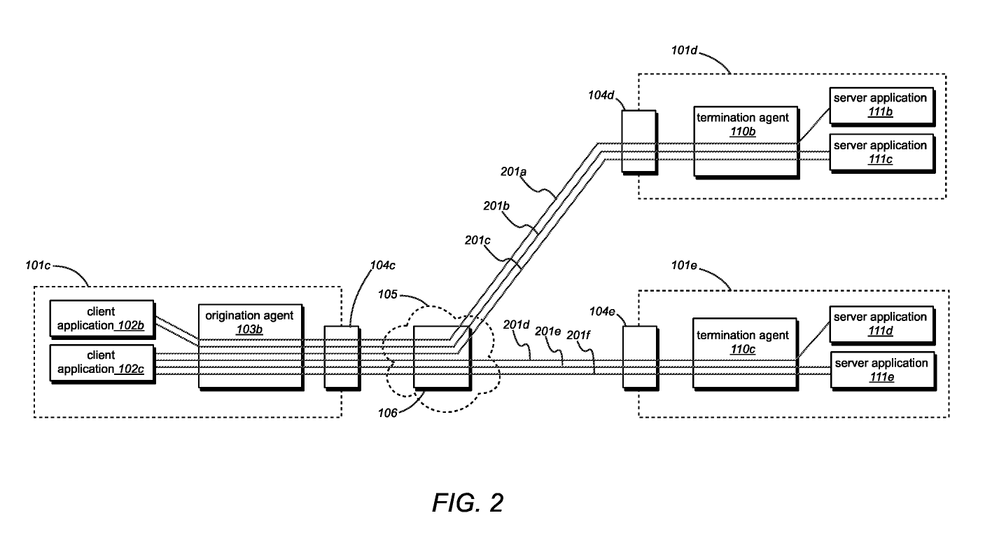

In a preferred embodiment, a multi-channel communication is supported, each channel being a virtual full-duplex TCP connection from the applications' perspective. This is illustrated by the example in FIG. 2. In this example, the application 102b in the network 101c communicates with the application 111b in the network 101d through the channel 201a. Simultaneously it communicates with the application 111c through the channel 201b. The application 102c communicates with the applications in two separate networks 101d and 101e. It communicates with the application 111c in the network 101d through the channel 201c. Simultaneously it communicates with application 111d in network 101e through the channel 201d. Simultaneously it also communicates with another application 111e in the network 101e through two channels 201e and 201f.

Other objects in FIG. 2 include the origination agent 103b, the relay server subsystem 106 in the public network 105, the termination agents 110b and 110c, and the edge routers 104c, 104d and 104e at the edges of different networks.

The example in FIG. 2 illustrates the flexibility of the disclosed multi-channel communication method. One client application can access server applications in different networks simultaneously, each through one or more channels. On the other hand, one server application can be accessed by the client applications from different networks simultaneously.

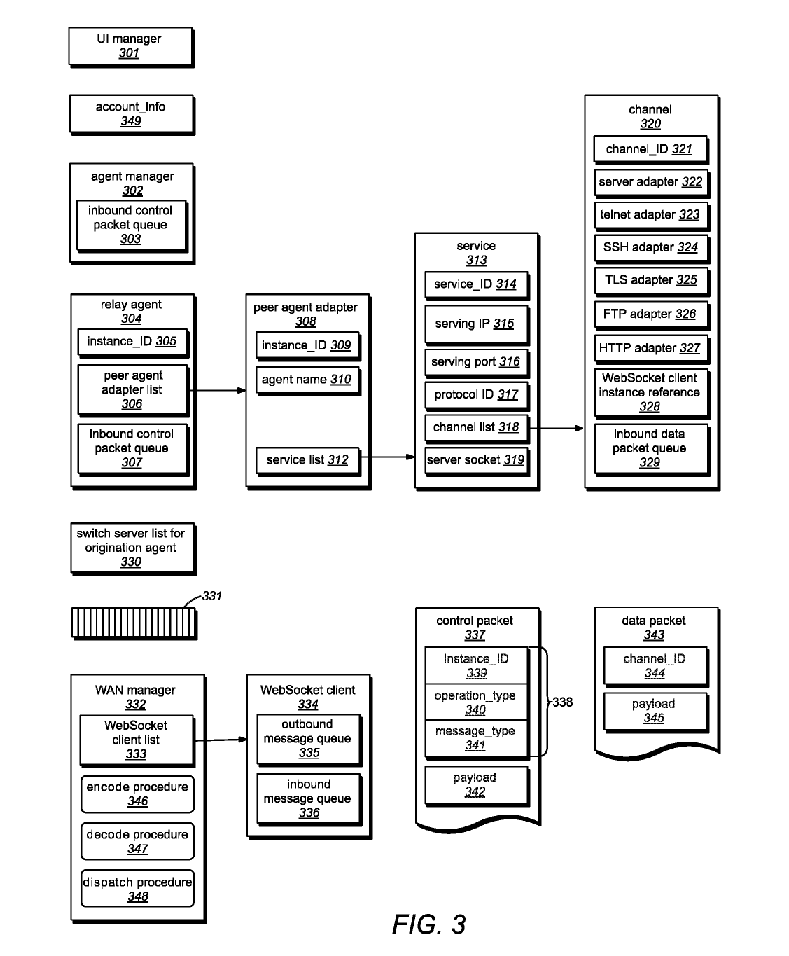

FIG. 3 illustrates the critical data structures used in a relay agent embodiment. The user interface manager definition 301 is for the system to provide and manage a user interface to communicate with users, and the relay agent manager definition 302 is for managing one or more relay agent instances.

The relay agent manager definition 302 contains an inbound control packet queue 303 for the inbound control data packets. Packets for different purposes may have different data structures.

The relay agent manager definition 302 also contains the relay agent definition 304. The relay agent definition 304 contains an integer field instance_ID 305 which is uniquely allocated by a control server to a relay agent instance in the login process. It identifies an agent instance in the relay system that the relay servers are ready to serve at a time. Its value ranges from 1 to MAX_INSTANCE, the maximal number of agents supported at the one time.

The relay agent definition also contains a peer agent adapter list 306 and an inbound control packet queue 307.

The peer agent adapter definition 308 is for the system to manage a peer agent. It contains the integer field instance_ID 309 and the peer agent name 310 and a service list 312.

Each server application that is allowed by the termination agent to access through a peer origination agent is defined and referred to as a service in the relay system.

A termination agent can create a service definition to maintain permission and information data for a specific origination agent to access a specific server application. The service class 313 contains an integer field service_ID 314, its value range is from 1 to MAX_SERVICE, where MAX_SERVICE is the maximal number of services the relay agent supports for an origination agent. It also contains a serving IP address 315, serving port 316, and protocol ID 317. It also contains a channel list 318 for multi-channel communication. It also contains a server socket 319. In an origination agent, a server socket instance listens on the serving port with the serving IP address for client applications.

The channel definition 320 contains an integer field channel_ID 321, its value ranges from 1 to MAX_CHANNEL, where MAX_CHANNEL is the maximal number of channels a relay agent supports at a time.

The channel definition 320 also contains the server adapter definition 322 to manage a TCP client socket and to connect to the server application for a termination agent or to bind to the server socket 319 for an origination agent.

The channel definition 320 also contains a WebSocket client instance reference 328 for sending outbound packets to the corresponding forwarding server. It also contains a queue 329 for the inbound data packets.

The channel definition 320 also contains a set of application protocol adapter definitions to parse and manipulate the user data for different protocols, for example, the Telnet adapter 323, the SSH adapter 324, TLS adapter 325, FTP adapter 326, HTTP adapter 327. Depending on the complexity of the protocols, the implementations of the adapters can be complex.

The data model also contains the account_info definition 349 for maintaining the user's account information, which is instantiated during the program startup and populated during the login process.

The data model may also contain a forwarding server list definition 330. An origination agent instance instantiates it to store the list of the forwarding server instances allocated by a control server in the login process.

The data model also contains a channel reference array definition 331. In a preferred embodiment, a channel reference array stores reference to the channels with the channel_ID equal to C (0<C≤MAX_CHANNEL) at the cell with the index equals to C (cell-C hereafter). When the system needs to forward a data packet to a channel identified by its channel_ID C, it gets the channel reference directly at the cell-C of the channel reference array by referencing the index, instead of traversing the service lists and the channel lists to address the target channel. This technology is referred to as index-addressing herein.

The data model also contains a WAN manager definition 332 to manage remote connections with relay servers. It contains a WebSocket client reference list 333. A relay agent instance may contain a set of WebSocket client instances implementing and managing WebSocket connections between the relay servers and the relay agent. A possible load balance mechanism chooses WebSocket client instances in the list 333 to send messages. An embodiment can choose and designate a specific instance to a channel during the creation of the channel; or it can choose a specific instance to send the message dynamically when a channel requests to send a message, by using different resource management algorithms. Choosing connections dynamically for each packet may result in a better balance of traffic, but it brings the complexity of making choices. In the disclosed embodiment, a channel always sticks to a designated WebSocket client instance and stores the reference by field 328. However, a WebSocket client instance can serve multi-channel instances.

There are different WebSocket client implementations publicly available. In a preferred implementation, the WebSocket client 334 contains an outbound message queue 335 and an outbound message queue 336. These are blocking-queues (which means an appending attempt will be blocked if the queue is full until one or more empty cells are available, and a taking attempt will be blocked if the queue is empty until one or more elements appear in the queue) and their capacities are configurable.

At the network level, data is transferred through WebSocket connections as WebSocket messages, each of which consists of one or more frames containing the data from the application systems. At the application level, a preferred embodiment exchange information or transfer data packets among different subsystems and procedures. Two types of packets are designed in the preferred embodiment: the control packet 337 for transferring control information; and the data packet 343 for transfer user data.

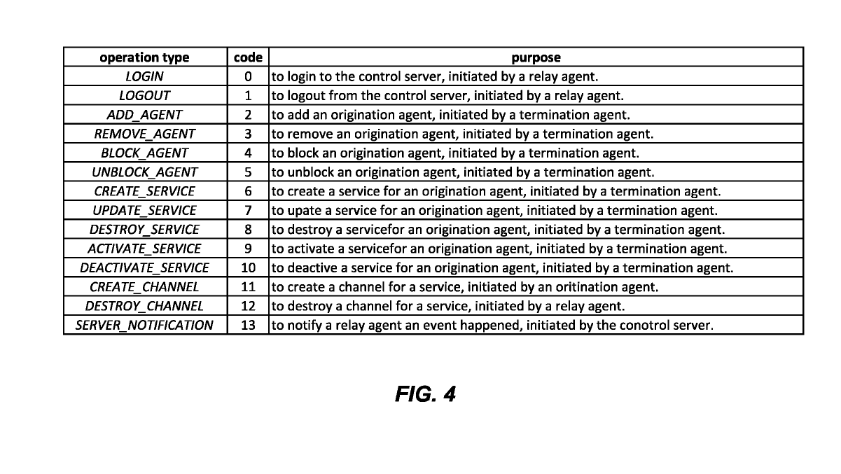

The control packet definition 337 is defined in the relay agent and control server data structures. It contains a header part 338 and a payload part 342. The header part comprises of three integer fields: the instance_ID field 339, the operation_type field 340 and the message_type field 341. The operation_type identifies the type of operations a request or response is for (see FIG. 4 for an example operation set). The message_type is value is REQUEST for a request packet, or RESPONSE for a response packet. The payload part 307 contains operation-specific information to be exchanged between the procedures dedicate to operations.

A control packet is sometimes referred to as a request or a response hereafter regarding the value of the message_type. In one embodiment, the first field of a response is always the operation_result field with its value equals to SUCCEEDED or FAILED.

The data packet definition 343 is defined in the relay agent and forwarding server. It contains a header part 344 and a payload part 345. The header part 344 consists of an integer field, the channel_ID of the channel transferring the data. The payload part 345 normally contains the user data.

Three basic procedures of the WAN manager data structure are disclosed herein. The encode procedure definition 346 is for encoding an application packet into a binary message. And the binary message is then wrapped into a WebSocket message and appended to the outbound message queue 335 for sending in serial by the WebSocket client. The decode procedure definition 347 consumes binary messages and produces application packets, by reversing the logic of the encode procedure. The dispatch procedure definition 348 is used by the system to dispatch application packets to different components of the relay agent, by examining the source of the incoming data and the header fields of the packets.

FIG. 4 illustrates a sample set of management operations a relay system embodiment supports and the corresponding operation_types. Generally, for each of the operation, there is an initialization procedure in either the relay agent or in the relay server and there is a corresponding handling procedure in either the relay server or in the relay agent accordingly. The initialization process may be triggered by an operation event from the user interface, a network event, or another operation handling procedure.

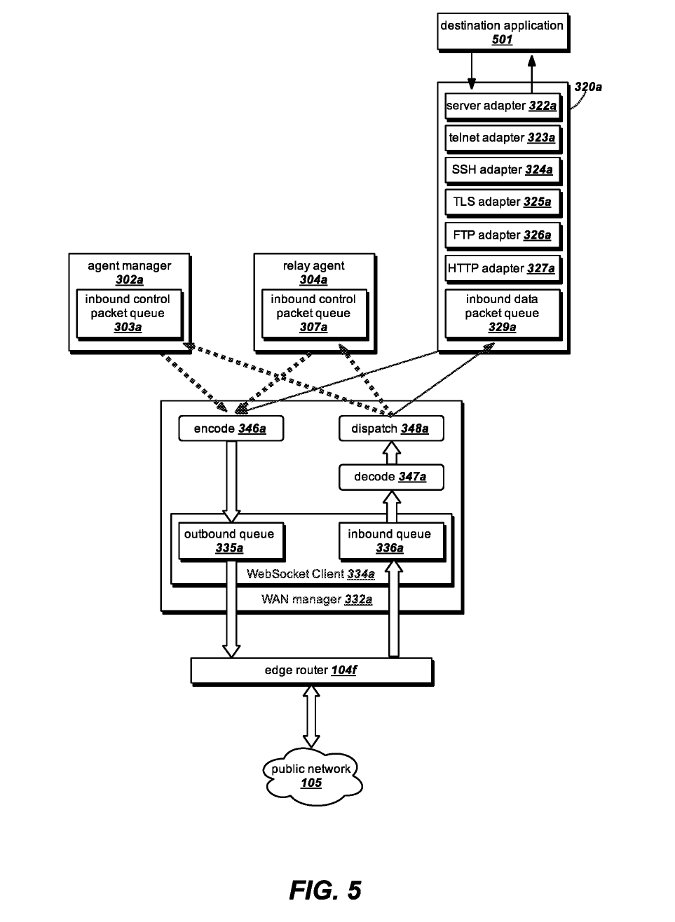

FIG. 5 illustrates the data flow among different objects of a relay agent embodiment. When a user triggers an operation from the user interface, the corresponding operation initialization procedure of the relay agent manager instance 302a or the relay agent instance 304a then creates an operation request and forward it to the encode procedure 346a. After it is encoded to a binary message, the WebSocket instance wraps it into one or more WebSocket messages and appends the messages to the outbound queue 335a. When a WebSocket message comes into the WebSocket client 334a, the client instance appends it to the inbound queue 336a waiting for a handling process instance to take. The decode procedure 347a decodes a binary message to an application data packet, and the dispatch procedure 348a then appends it to either the inbound packet queue 303a or 307a or 329a. Taking the inbound data packet queue 329 for instance, an inbound data handling procedure instance takes the packet from the inbound queue and forwards it to a specific protocol adapter instance (323a, 324a, 325a, 326a, 327a, etc.) for a specific channel instance against its protocol_ID_and channel_ID, and may then forward the returned bytes to the server adapter 322a. The service adapter finally forwards the manipulated user data to the target application 501.

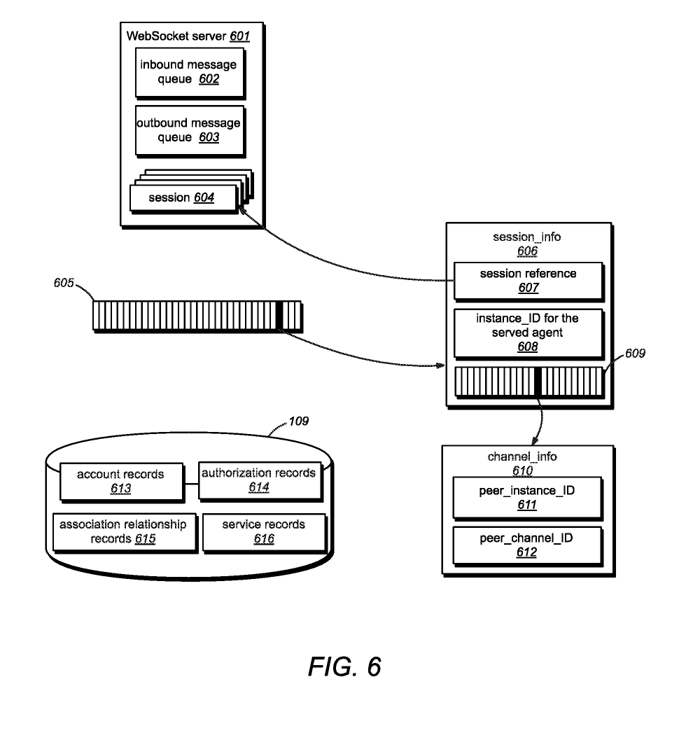

FIG. 6 illustrates the critical data structures used in a relay server subsystem embodiment. A WebSocket server embodiment 601 manages the WebSocket connections between the server and the relay agents. There are different WebSocket server implementations publicly available (e.g., Glassfish, Jetty, Node.js, etc.). In a preferred implementation, the WebSocket server contains an inbound message queue definition 602 and an outbound message queue definition 603, and these are blocking-queues and their capacities are configurable. The WebSocket server manages each WebSocket connection context as a session 604. The WebSocket server allows a running process to send messages to a specific client by evoking the message sending facility by referencing the session serving that client.

A session_info definition 606 is defined for an agent during the login time to maintain application specific information for each session instance; it contains a session reference definition 607 and the instance_ID 608 field the served relay agent.

The session_info_array definition 605 is the array stores the references of all the session_info instances in the subsystem for index-addressing by using instance_ID.

To support the multi-channel communication, the session_info definition 606 also contains a channel_info_array definition 609 which stores the references of the channel_info instances for index-addressing by using channel_ID. The channel_info definition 610 maintains the information of a communication channel needed in the processes in the forwarding servers. It contains two fields: the peer_instance_ID 611 indicating the instance_ID of the peer agent and the peer_channel_ID 612 indicating the channel_ID of the managed channel in the peer agent. a channel_info instance is created during the creating process and destroyed during the destroying process of the managed channel. The channel_ID value ranges from 0 to MAX_CHANNEL_ID, where MAX_CHANNEL_ID is the maximal number of channels allowed to create a relay agent at a time.

In one embodiment, information in data store 109 contains instances of account record definition 613, instances of authorization record definition 614, instances of termination-origination relationships definition 615, and instances of service record definition 616.

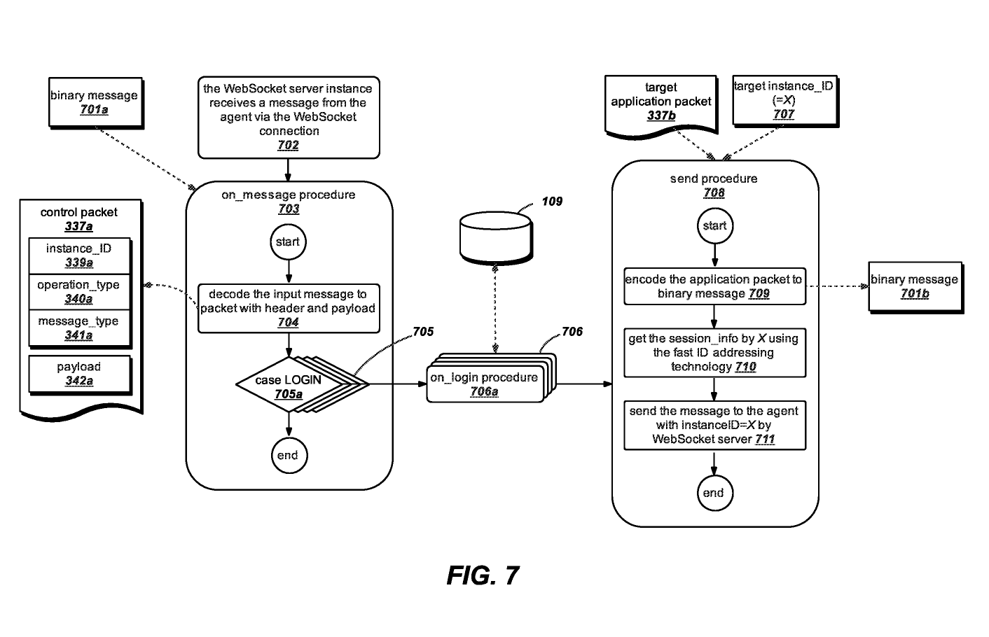

In the present disclosure, the relay server application logic is driven by requests from the relay agents. FIG. 7 illustrates the general request handling flow of a control server embodiment. When the WebSocket server receives a message (procedure 702), the on_message procedure 703 is evoked. It takes the received binary message 701a as input and decodes it to an application packet 337a (procedure 704).

The system then checks against the operation_type 340a and dispatches the packet to the corresponding operation handling procedure 706 (procedure 705). For example, if the operation_type equals to LOGIN (case 705a), it evokes the on_login procedure 706a to handle the login operation. The system may query and/or update the data store 109 one or more times during the execution. The system evokes the sending procedure 708 to send one or more requests or responses to specific agents. The sending procedure takes the source packet 337b and the instance_ID 707 (equals to X, for instance) of the target agent as its input. It first encodes the packet to a binary message 701b (procedure 709) and then gets the session_info instance by index-addressing for sending, and then the relay server sends the WebSocket packet to the relay agent (procedure 711) and ends.

As illustrated in FIG. 7, the implementation of the relay controls is modeled as operation handling procedures 706. Among which, two procedures, procedure on_login for handling login request and procedure on_create_channel for handling creating channel operation are further illustrated.

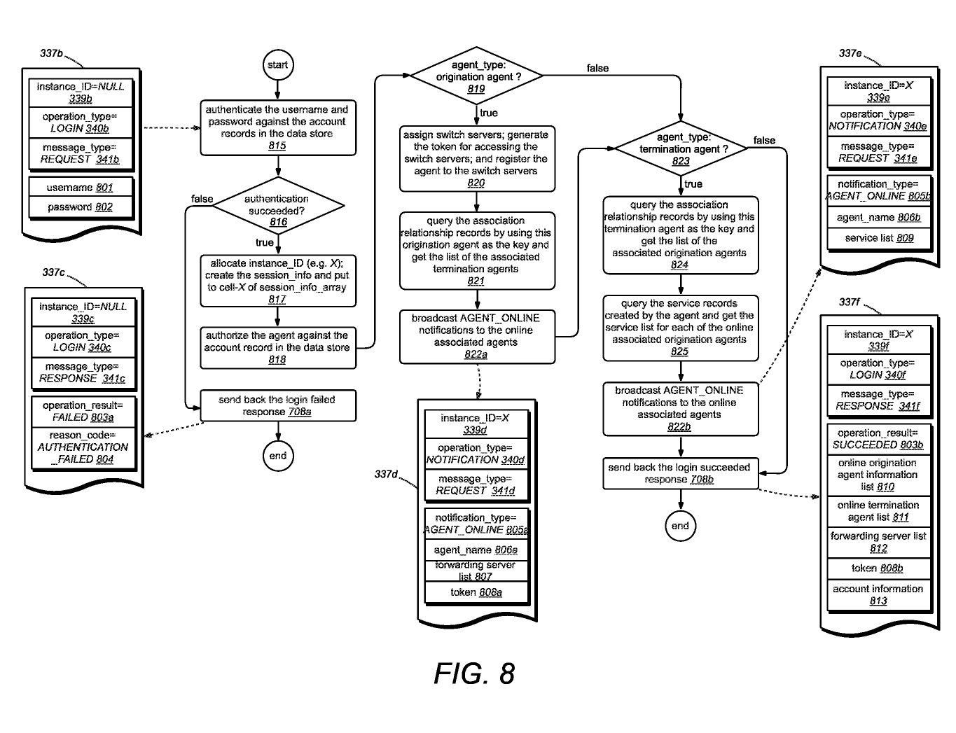

FIG. 8 illustrates the on_login procedure in a control server embodiment. It takes a login request 337b as input. The header field instance_ID 339b of the request equals to NULL and yet to be allocated, the operation_type 340b equals to LOGIN and the message_type 341b equals to REQUEST. The operation-specific payload part contains a username 801 and a password 802.

The system first authenticates the user by the username and the password against the account record 613 in the data store 109 (procedure 815). It then checks the authentication result (case 816).

If the authentication failed, it sends a response 337c back to the relay agent indicating login failed (procedure 708a) and ends. In the payload, two operation-specific fields are contained: operation_result field 803a is set to FAILED, and reason_code field 804 is set to AUTHENTICATION_FAILED indicates the reason of failure.

If the authentication succeeds, the system creates an instance_ID instance for the relay agent. It also creates a session_info instance and stores its reference in the session_info_array 605 for index-addressing. This is illustrated in procedure 817.

The system then authorizes the relay agent against the account record 613 in the data store (procedure 818). Among others, the system checks the relay agent_type field of the account record of the user. The relay agent_type indicates whether a relay agent instance is allowed to work as origination agent or termination agent. The system first checks whether the relay agent is allowed to act as origination agent or not (procedure 819).

If yes, the system assigns one or more forwarding servers to the relay agent using a certain resource monitor and allocate strategy. It may then generate a token for the relay agent to access these forwarding servers and registers the relay agent to them (procedure 820). It then queries the origination-termination relationship records 615 in the data store and gets the list of online termination agents who added the requesting agent as an origination agent (procedure 821).

It then broadcasts agent online notifications to the relay agents in the online termination agent list (procedure 822a). In the request 337d, the instance_ID 339d is set to X, the operation_type 340d is set to NOTIFICATION and the message_type 341d is set to REQUEST. The payload comprises the notification_type 805a with value AGENT_ONLINE, the relay agent_name 806a, and the forwarding server list 807 to be used for forwarding data by the origination agent so the termination agent can connect to the specified forwarding servers for receiving, and the token 808 for accessing the forwarding servers.

If no, procedures 820, 821 and 822a are skipped.

The system then checks whether the relay agent is allowed to act as termination agent or not (case 823).

If yes, it queries the origination-termination relationship records in the data store and gets the list of online origination agents who were added by the relay agent as origination agents (procedure 824). It then queries the service records 416 from the data store, which are added by the relay agent for each of the origination agents in the online origination agent list (procedure 825).

The system then broadcasts agent online notifications to the relay agents in the online origination agent list (procedure 822b). In the request 337e, the instance_ID 339e is set to X, the operation_type 340e is set to NOTIFICATION and the message_type 341e is set to REQUEST. The payload comprises the notification_type 805b with value AGENT_ONLINE, the relay agent_name 806b and the service list for the origination agent 809.

If no, procedures 824, 825 and 822b are skipped.

The system then sends a login response 337f to the requesting relay agent (procedure 708b) and ends. In the payload part, the operation_result 803b is set to SUCCEEDED. If the relay agent is allowed to act as termination agent, the payload also contains the online origination agent information list 810. If the relay agent is allowed to act as origination agent, the payload also contains the online termination agent list 811, the forwarding server list 812 and the authentication token to access the forwarding servers 813. The payload also contains the user's account information 814, including the relay agent_type.

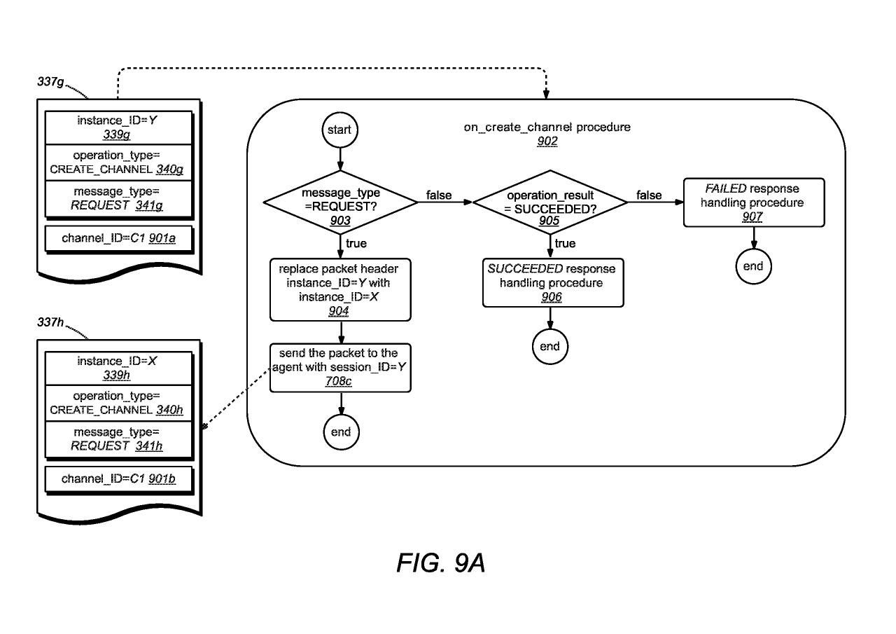

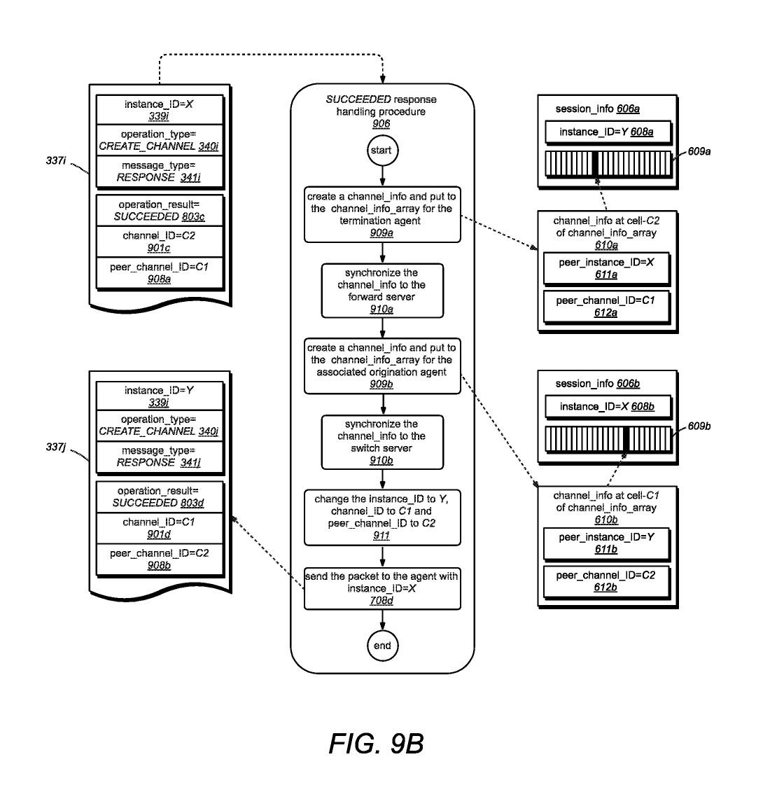

FIG. 9A illustrates a creating channel procedure in a control server embodiment.

Suppose the request comes from an origination agent with its instance_ID equals to X for creating a channel at a termination agent with its instance_ID equals to Y. In the request instance 337g, the relay agent instance_ID 339g equal to Y, the operation_type 340g equals to CREATE_CHANNEL, and the message_type 341g equals to REQUEST. The payload contains a channel_ID 901a equals to C1, which is allocated by the origination agent for the target channel.

The system evokes the on_create_channel procedure 902. It first checks the message_type (case 903).

If it is a request, the system gets the instance_ID value X from the session_info (606) instance and replaces the header field instance_ID value Y with value X (procedure 904). It then forwards the request to the target termination agent with instance_ID equals to Y (procedure 708c). At the time point, the request is sent to the termination agent but the channel is still not set up yet and the requesting relay agent is waiting for the response from the control server.

When the termination agent with it instance_ID equals to Y receives the request message, it checks the resources and tries to build the channel and create the socket connects to the destination server application. It also tries to allocate a local channel_ID (C2 for instance) for the channel. If all steps succeeded it sends a SUCCEEDED response to the control server; otherwise, it sends a FAILED response to the control server.

When the control server receives the response, the system checks the operation_result field of the payload in a response (procedure 905). If the operation_result is SUCCEEDED, it evokes the handling procedure 906; and if it is FAILED, it evokes the handling procedure 907.

FIG. 9B illustrates the creating channel SUCCEEDED response handling procedure 906. The system takes the response 337i as input. The header field instance_ID 337i equals to X, operation_type 340i equals to CREATE_CHANNEL, and message_type 341i equals to RESPONSE. The payload contains the operation_result 803c equals to SUCCEEDED, the channel_ID 901c equals to C2 which is allocated by the termination agent; and the peer_channel_ID 908a equals to C1 which is allocated by the origination agent.

The system creates a channel_info instance 610a with the peer_instance_ID 611a equals to X and the peer_channel_ID 612a equals to C1. It then put a reference of the channel_info to the cell-C2 of the channel_info_array 609a of the session_info instance 606a, where the instance_ID 608a of the session_info instance equals to Y (procedure 909a).

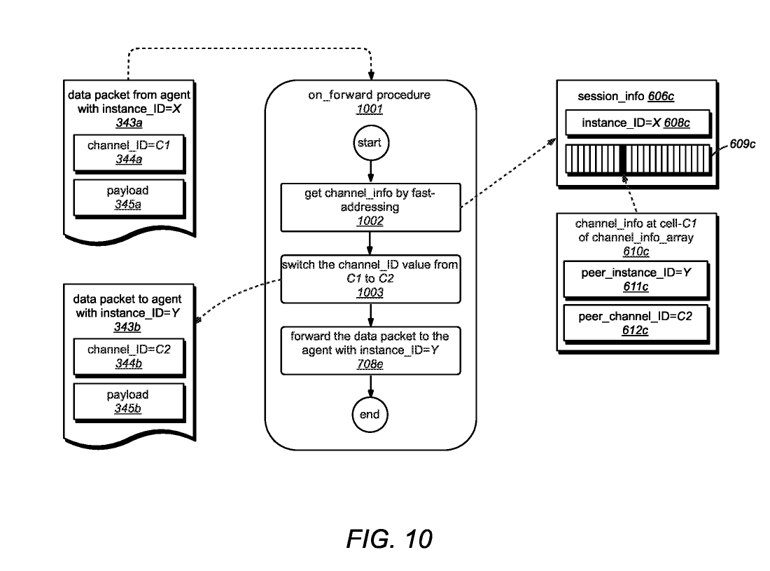

The system then synchronizes the channel_info to the corresponding forwarding servers so that they can use it to switch the channel_ID value from C2 to C1 and forward data packets from the termination agent with the instance_ID equals to Y to the origination agent with the instance_ID equals to X, as illustrated in FIG. 10 (procedure 910a).

The system then creates a channel_info instance 610b with the peer_instance_ID 611b equals to Y and the peer_channel_ID 612b equals to C2. It then put a reference of the channel_info to the cell-C1 of the channel_info_array 609b of the session_info instance 606b, where the instance_ID 608b of the session_info instance equals to X (procedure 909b).

The system then synchronizes the channel_info to the corresponding forwarding servers so that they can use it to switch the channel_ID value from C1 to C2 and forward a data packet from the origination agent with the instance_ID equals to X to the termination agent with the instance_ID equals to Y, as illustrated in FIG. 10 (procedure 910b).

The system then changes the instance_ID from X to Y in the header, changes the channel_ID from C2 to C1 and changes the peer_channel_ID from C1 to C2 in the payload in the response packet indicating the responding agent (procedure 911). It then sends the packet 337j to the origination agent with instance_ID equals to X by the sending procedure 708d and ends. After the origination agent receives the response, the channel is created; it may start to parse and forward the data to the termination agent via allocated forwarding servers.

FIG. 10 illustrates a preferred data packet switch-and-forward procedure 1001 in a forwarding server. For simplicity, an embodiment of the relay system assumes there is only one forwarding server serves a channel during its lifetime.

By utilizing the data structures illustrated in FIG. 3 and FIG. 6 and the index-addressing technology, the switch-and-forward process is simple and fast thus guarantees the performance of the overall system. It first checks the channel_ID field 344a of the data packet 343a and gets the reference to channel_info instance 610c from the session_info 606c by index-addressing (procedure 1002); it then switches the channel_ID field in the data packet from C1 to C2 regarding peer_channel_ID 612c; and it then forwards the packet to the relay agent with its instance_ID equals to Y by the sending procedure 708e regarding peer_instance_ID 611de and ends.

In an embodiment of the relay system, for security reasons, a surveillance agent is implemented based on the application protocol proxy functionalities. Thus, the entire communication can be monitored in real-time.

In an embodiment of the relay system, the control servers and the forwarding servers are combined into one relay server but use different WebSocket connections for control and data.

In an embodiment of the relay system, the control servers and the forwarding servers are combined into one relay server and use one single WebSocket connection for control and data. The outbound queue size of the WebSocket client should not be too large, otherwise, the queue may be flooded with data packets in some case (e.g. FTP, HTTP download) and the control operations will be noticeably delayed.

The foregoing description and accompanying drawings illustrate the principles, preferred or exemplary embodiments, and modes of assembly and operation, of the invention; however, the invention is not, and shall not be construed as being exclusive or limited to the specific or particular embodiments set forth hereinabove.

What is claimed is:

1. A computing-devices-implemented relay system for enabling communications among isolated origination networks and destination networks, comprising:
a relay server subsystem comprising a plurality of publicly addressable relay servers, the plurality of publicly addressable relay servers comprising one or more control servers and one or more forwarding servers;
a relay agent subsystem comprising a plurality of relay agents, the plurality of relay agents comprising
one or more origination agents residing in the origination networks, each origination agent serving a set of client applications, and
one or more termination agents residing in the destinations networks, each termination agent serving a set of server applications;
wherein the publicly addressable control servers are configured to control the relay agents to access and use the relay servers;
wherein the forwarding servers are configured to forward data among relay agents;
wherein relay servers are configured to use sessions to manage relay agents;
wherein the relay agents are configured to create and manage communication sessions with the relay servers;
wherein each termination agent is configured to communicate with a destination application locally representing a remote origination client residing in an isolated origination network; and
wherein each origination agent is configured to communicate with an origination client locally representing a remote destination application residing in an isolated destination network.

2. The computing-devices-implemented relay system of claim 1, wherein WebSocket protocol is utilized for persistent full duplex TCP/IP connections between the relay servers and the relay agents.

3. The computing-devices-implemented relay system of claim 1, wherein Transport Layer Security (TLS) protocol is used to secure the WebSocket communication between relay servers and relay agents.

4. The computing-devices-implemented relay system in claim 1, wherein the relay server subsystem further comprises a set of data stores storing users' credentials, service subscriptions and usage history for the relay servers to authorize and authenticate users and to control the data flow.

5. The computing-devices-implemented relay system in claim 1, wherein each control server is further configured to manage the forwarding server resources available to each specific relay agent.

6. The computing-devices-implemented relay system in claim 1, wherein each forwarding server is further configured to manage peer agents and channel information for each of them for each communication session representing a served agent.

7. The computing-devices-implemented relay system in claim 1, wherein each forwarding server is further configured to coordinate between origination agents and destination agents to manage channels.

8. The computing-devices-implemented relay system in claim 1, wherein each forwarding server further comprises a switching method to switch data packets among peer agents for each channel.

9. The computing-devices-implemented relay system in claim 1, wherein each relay agent is further configured to manage channels with the coordination of forwarding servers.

10. The computing-devices-implemented relay system in claim 1, wherein each relay agent is further configured to manage its coupled peer agents.

11. The computing-devices-implemented relay system in claim 1, wherein each origination agent is further configured to initiate coupling requests to termination agents.

12. The computing-devices-implemented relay system in claim 1, wherein each origination agent is further configured to manage a set of origination applications in its accessible networks.

13. The computing-devices-implemented relay system in claim 1, wherein each termination agent is further configured to process coupling requests from origination agents.

14. The computing-devices-implemented relay system in claim 1, wherein each termination agent is further configured to manage a set of origination agents.

15. The computing-devices-implemented relay system in claim 1, wherein the relay agent subsystem further comprises one or more protocol adapters for specific application protocols to manipulate application data and build end to end virtual TCP/IP connections between a client application and a server application in two isolated IP networks.

16. The computing-devices-implemented relay system in claim 1, wherein each relay agent is further configured to manage multi processes or threads to utilize multi-CPU to process inbound and outbound data packets in parallel.

17. The computing-devices-implemented relay system in claim 1, wherein each relay agent is further configured to provide an interface for human users to use the system.

18. The computing-devices-implemented relay system in claim 1, further comprising a method of using channels to manage multiple virtual TCP/IP connections between an origination application and a destination application.

19. The computing-devices-implemented relay system in claim 18, wherein each relay agent further comprises an inbound queue for each channel.

20. The computing-devices-implemented relay system in claim 18, wherein each relay agent is further configured to dispatch inbound data packets to the destination channels' inbound queue.
